(19) United States
(12) Patent Application Publication
(10) Pub. No.: US 2025/0053750 A1
(43) Pub. Date: Feb. 13, 2025

(54) COMPUTER SYSTEM AND METHOD FOR GENERATING INTERPRETATION SENTENCE

(71) Applicant: Hitachi, Ltd., Tokyo (JP)

(72) Inventors: Kohei MATSUSHITA, Tokyo (JP); Masaki HAMAMOTO, Tokyo (JP); Masayoshi MASE, Tokyo (JP); Masashi EGI, Tokyo (JP)

(21) Appl. No.: 18/791,514

(22) Filed: Aug. 1, 2024

(30) Foreign Application Priority Data
Aug. 10, 2023 (JP) 2023-131099

(51) Int. Cl. G06F 40/35

(52) U.S. Cl. CPC G06F 40/35

(57) ABSTRACT

A computer system stores a large-scale language model that receives an instruction sentence as an input and outputs an interpretation sentence for interpreting a result of an inference, and text template information that stores template data in which a characteristic of a contribution value of a feature in a group having features is associated with a template of the instruction sentence, calculates the contribution value of each of a plurality of the features, generates a plurality of groups each constituted with one or more of the features, acquires, for each of the plurality of groups, the template data by referring to the text template information based on the characteristic of the contribution value of the feature included in the group, generates, based on the template data and the feature included in the group, the instruction sentence to be input to the large-scale language model, and outputs the interpretation sentence obtained.

### CLAIM OF PRIORITY

The present application claims priority from Japanese patent application JP 2023-131099 filed on Aug. 10, 2023, the content of which is hereby incorporated by reference into this application.

### BACKGROUND OF THE INVENTION

### 1. Field of the Invention

The present disclosure relates to a computer system and a method for generating an interpretation sentence for an inference result of a machine learning model.

### 2. Description of Related Art

As a related art of the present disclosure, for example, PTL 1 is known. PTL 1 discloses a system that presents data useful for a user to interpret a basis of a prediction result output by AI. For example, PTL 1 discloses a “computer system that stores interpretation factor conversion information for managing an interpretation factor interpreting a basis of a prediction result for input data including values of a plurality of features, the interpretation factor being determined by the value of each of the plurality of features included in the input data and contribution values of the plurality of features included in the input data, calculates a prediction result for evaluation target data when the evaluation target data is input, calculates a contribution value of each of the plurality of features included in the evaluation target data, specifies a corresponding interpretation factor by referring to the interpretation factor conversion information based on the value and the contribution value of each of the plurality of features included in the evaluation target data, and generates and outputs display information for presenting the specified interpretation factor” (for example, see Abstract).

### CITATION LIST

### Patent Literature

PTL 1: JP2020-123164A

### SUMMARY OF THE INVENTION

In order to generate the interpretation factor conversion information of PTL 1, knowledge of an expert is indispensable, and there is a problem that the above technique cannot be used when the expert cannot specify the interpretation factor.

The present invention provides a system and a method that use a language model to present a business interpretation without requiring knowledge of an expert.

A representative example of the invention disclosed in this application is as follows. That is, a computer system, which is connected to an inference system that receives input data including a plurality of features and performs an inference using an inference model, stores a large-scale language model that receives an instruction sentence as an input and outputs an interpretation sentence for interpreting a result of the inference, and first text template information that stores first template data in which a characteristic of a contribution value indicating a magnitude of a contribution to the result of the inference of a feature in a group constituted with one or more features is associated with a template of the instruction sentence, calculates the contribution value of each of the plurality of features using the input data, the result of the inference, and the inference model, generates a plurality of groups each constituted with one or more of the features, acquires, for each of the plurality of groups, the first template data by referring to the first text template information based on the characteristic of the contribution value of the feature included in the group, generates, based on the acquired first template data and the feature included in the group, the instruction sentence to be input to the large-scale language model, and outputs the interpretation sentence obtained by inputting the instruction sentence to the large-scale language model.

According to an aspect of the present disclosure, the computer system can present an interpretation sentence for an inference result of an inference model. Problems, configurations, and effects other than those described above will be clarified by the description of the following embodiments.

### BRIEF DESCRIPTION OF THE DRAWINGS

FIG. 1 is a diagram showing an example of a hardware configuration of a computer system according to Embodiment 1;

FIG. 2A is a diagram showing an example of a software configuration of an inference device according to Embodiment 1;

FIG. 2B is a diagram showing an example of a software configuration of an interpretation sentence generation device according to Embodiment 1;

FIG. 3 is a diagram showing an example of a data structure of input data according to Embodiment 1;

FIG. 4 is a diagram showing an example of a data structure of contribution value information according to Embodiment 1;

FIG. 5 is a diagram showing an example of a data structure of feature information according to Embodiment 1;

FIG. 6 is a diagram showing an example of a data structure of a feature list according to Embodiment 1;

FIG. 7 is a diagram showing an example of a data structure of group information according to Embodiment 1;

FIG. 8A is a diagram showing an example of a data structure of first text template information according to Embodiment 1;

FIG. 8B is a diagram showing the example of the data structure of the first text template information according to Embodiment 1;

FIG. 9 is a diagram showing an example of a data structure of prompt information according to Embodiment 1;

FIG. 10 is a diagram showing an example of a data structure of analysis information according to Embodiment 1;

FIG. 11 is a diagram showing an example of a data structure of second text template information according to Embodiment 1;

FIG. 12 is a diagram showing an example of a data structure of relationship document information according to Embodiment 1;

FIG. 13 is a diagram showing an example of a data structure of a table for managing interpretation sentences according to Embodiment 1;

FIG. 14 is a flowchart illustrating an outline of processing executed by the interpretation sentence generation device according to Embodiment 1;

FIG. 15 is a flowchart illustrating an example of feature selection processing executed by the interpretation sentence generation device according to Embodiment 1;

FIG. 16 is a flowchart illustrating an example of prompt generation processing executed by the interpretation sentence generation device according to Embodiment 1;

FIG. 17 is a flowchart illustrating an example of relationship document generation processing executed by the interpretation sentence generation device according to Embodiment 1;

FIG. 18 is a flowchart illustrating an example of filtering processing executed by the interpretation sentence generation device according to Embodiment 1;

FIG. 19 is a diagram showing an example of a screen displayed by a feature presentation unit according to Embodiment 1;

FIG. 20 is a diagram showing an example of a screen displayed by a prompt presentation unit according to Embodiment 1;

FIG. 21 is a diagram showing an example of a screen displayed by an analysis result presentation unit according to Embodiment 1; and

FIG. 22 is a diagram showing an example of a screen displayed by a result presentation unit according to Embodiment 1.

### DESCRIPTION OF EMBODIMENTS

Hereinafter, embodiments of the invention will be described in detail with reference to the drawings. When necessary for convenience, the description will be divided into a plurality of sections or embodiments, but unless otherwise specified, they are not unrelated to each other, and one has a relation with all or a part of modifications, details, supplementary explanations, and the like of the other. Hereinafter, when referring to the number of elements (including the number, numerical values, amounts, ranges, or the like) or the like, the number of elements is not limited to a specific number, and may be the specific number or more or the specific number or less, unless otherwise specified or except a case where the number is apparently limited to a specific number in principle.

A system of one embodiment of the present specification may be a physical computer system (one or more physical computers) or may be a system built on a calculation resource group (plurality of calculation resources) such as a cloud infrastructure. The computer system or the calculation resource group may include one or more interface devices (including, for example, a communication device and an input and output device), one or more storage devices (including, for example, a memory (main memory) and an auxiliary storage device), and one or more calculation devices.

When a function is implemented by the calculation device executing a program including an instruction code, predetermined processing is executed appropriately using the storage device and/or the interface device or the like, and thus the function may be at least a part of the calculation device. Processing described with the function as a subject may be processing executed by the calculation device or a system including the calculation device. The program may be installed from a program source.

The program source may be, for example, a program distribution computer or a computer-readable storage medium (for example, a computer-readable non-transitory storage medium). A description of each function is an example, and a plurality of functions may be integrated into one function, or one function may be divided into a plurality of functions.

### Embodiment 1

FIG. 1 is a diagram showing an example of a hardware configuration of a computer system according to Embodiment 1.

The computer system shown in FIG. 1 includes an inference device 110, an interpretation sentence generation device 100, and a user terminal 120. The devices are connected to each other via a network 130. Any type of the network 130 is possible, and for example, a wide area network (WAN), a local area network (LAN), and the like are possible. A connection method of the network 130 may be wired or wireless.

The inference device 110 performs various inferences using an inference model. In the present embodiment, an inference model for predicting a fire probability of a property will be described as an example.

The inference device 110 includes a CPU 111, a memory 112, an auxiliary storage device 113, and a network interface 114 as hardware. The hardware elements communicate with each other via an internal bus.

The CPU 111 executes a program stored in the memory 112. The memory 112 stores a program executed by the CPU 111 and information necessary for the program. The memory 112 includes a work area temporarily used by the program.

The auxiliary storage device 113 permanently stores data. The auxiliary storage device 113 is considered to be a storage medium such as a hard disk drive (HDD) or a solid state drive (SSD), a non-volatile memory, or the like. The program and the information stored in the memory 112 may be stored in the auxiliary storage device 113. In this case, the CPU 111 reads the program and the information from the auxiliary storage device 113, loads the program and the information into the memory 112, and executes the program loaded in the memory 112. The network interface 114 is connected to other devices via a network.

The interpretation sentence generation device 100 generates an interpretation sentence reflecting business knowledge to which an inference is applied from an inference result, and presents the interpretation sentence to a user who uses the inference device 110.

The interpretation sentence generation device 100 includes a CPU 101, a memory 102, an auxiliary storage device 103, and a network interface 104 as hardware. The hardware elements communicate with each other via an internal bus or the like. The CPU 101, the memory 102, the auxiliary storage device 103, and the network interface 104 are hardware elements similar to the CPU 111, the memory 112, the auxiliary storage device 113, and the network interface 114.

The user terminal 120 is a terminal used by the user. The user terminal 120 receives a user input for generating an interpretation sentence of an inference result, and presents the generated interpretation sentence to the user. The user terminal 120 includes a CPU 121, a memory 122, an auxiliary storage device 123, a network interface 124, an input device 125, and an output device 126 as hardware. The hardware elements communicate with each other via an internal bus.

The CPU 121, the memory 122, the auxiliary storage device 123, and the network interface 124 are hardware elements similar to the CPU 111, the memory 112, the auxiliary storage device 113, and the network interface 114.

The input device 125 is a device for inputting data and the like, and includes a keyboard, a mouse, a touch panel, and the like. The output device 126 is a device for outputting data and the like, and includes a display, a touch panel, and the like.

In the above devices, the CPU executes processing according to the program to operate as a functional unit having a predetermined function. In the following description, when processing is described with the program as a subject, it indicates that the CPU or a device on which the CPU is mounted executes the program for implementing the functional unit.

In the configuration example of FIG. 1, different computers execute tasks of operation management, decision-making support, and user interface, respectively. In other examples, a combination of all or some of these tasks may be executed by one computer. For example, the inference device 110 and the interpretation sentence generation device 100 may be implemented as a virtual computer operating on one computer.

As described above, the computer system may be implemented by one or more computers including one or more calculation devices and one or more storage devices including a non-transitory storage medium. A memory, an auxiliary storage device, or a combination thereof is the storage device. The CPU is an example of the calculation device. The calculation device may be implemented by a single processing unit or a plurality of processing units, and may include a single or a plurality of calculation units or a plurality of processing cores. The calculation device may be implemented as one or more central processing units, a microprocessor, a microcomputer, a microcontroller, a digital signal processor, a state machine, a logic circuit, a graphics processing device, a chip-on-system, and/or any device for operating a signal based on a control instruction.

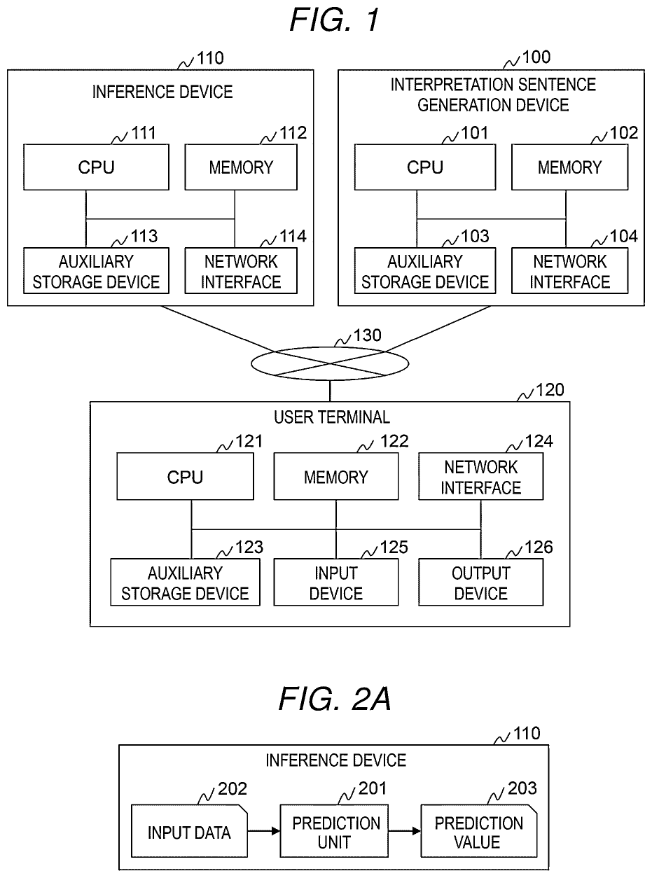

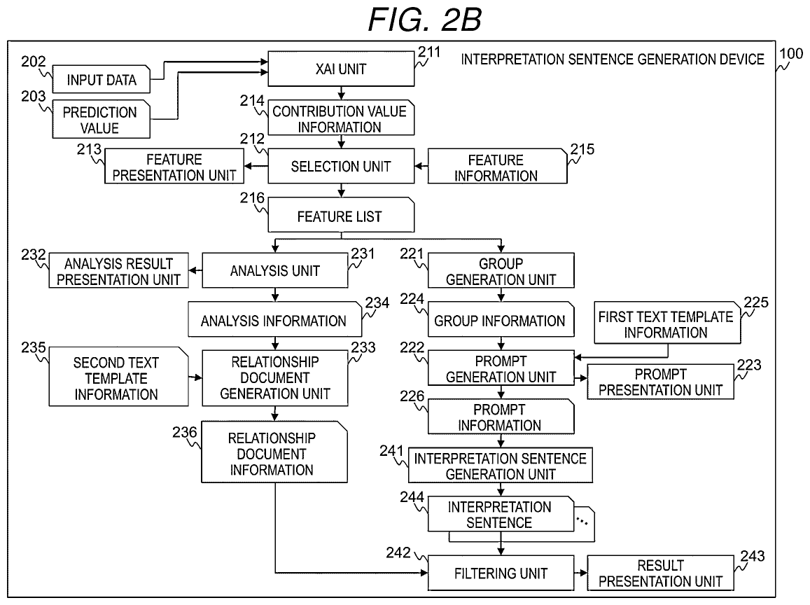

FIG. 2A is a diagram showing an example of a software configuration of the inference device 110 according to Embodiment 1.

The inference device 110 includes a prediction unit 201 that performs prediction using the inference model. The prediction unit 201 executes processing using the inference model on input data 202, and outputs a prediction value 203.

FIG. 2B is a diagram showing an example of a software configuration of the interpretation sentence generation device 100 according to Embodiment 1.

The interpretation sentence generation device 100 includes an explainable artificial intelligence (XAI) unit 211, a selection unit 212, a feature presentation unit 213, a group generation unit 221, a prompt generation unit 222, a prompt presentation unit 223, an analysis unit 231, an analysis result presentation unit 232, a relationship document generation unit 233, an interpretation sentence generation unit 241, a filtering unit 242, and a result presentation unit 243.

The XAI unit 211 acquires the input data 202 and the prediction value 203 from the inference device 110, and calculates a contribution value of each feature of the input data 202 for the prediction value 203. The contribution value of each feature is output as contribution value information 214.

The XAI unit 211 calculates the contribution value using a known algorithm. For example, Shapley additive explanation (SHAP), local interpretable model-agnostic explanations (LIME), integrated gradient, or the like may be used.

The selection unit 212 acquires the contribution value information 214 from the XAI unit 211, refers to feature information 215, verbalizes the feature, and selects a feature used for generating an interpretation sentence based on the contribution value of each feature. The selected verbalized features are output as a feature list 216. In the following description, a feature that is verbalized is referred to as a verbalized feature.

The feature presentation unit 213 displays the verbalized feature selected by the selection unit 212 on a screen to the user terminal 120.

The group generation unit 221 acquires the feature list 216 from the selection unit 212 and generates a plurality of groups having the verbalized features as elements. The group of the verbalized features is constituted with at least one verbalized feature. The generated group is output as group information 224.

The prompt generation unit 222 acquires the group information 224 from the group generation unit 221, refers to first text template information 225, and generates a prompt for each group. Here, the prompt is an instruction sentence to be input to a large-scale language model to be described later. The prompt generation unit 222 outputs prompt information 226 that stores the prompt of each group.

The prompt presentation unit 223 displays the prompt generated by the prompt generation unit 222 on a screen to the user terminal 120.

The analysis unit 231 acquires the feature list 216 from the selection unit 212, and analyzes a relationship between a value of the feature and the contribution value.

In the present embodiment, the analysis unit 231 uses the XAI unit 211 to generate, as an analysis result, a graph representing a relationship between a value of a selected feature and a contribution value for a prediction value (fire probability).

The analysis result presentation unit 232 displays the analysis result of the analysis unit 231 on a screen to the user terminal 120. The user checks the screen, and inputs information related to the relationship as necessary using the user terminal 120. The analysis unit 231 outputs the information input via the user terminal 120 and the analysis result as analysis information 234.

The relationship document generation unit 233 acquires the analysis information 234 from the analysis unit 231, refers to second text template information 235, and generates one or more relationship documents by verbalizing the relationship included in the analysis information 234. The relationship document generation unit 233 outputs relationship document information 236 that stores one or more relationship documents.

The interpretation sentence generation unit 241 acquires the prompt information 226 from the prompt generation unit 222, and generates an interpretation sentence by inputting the prompt to the large-scale language model. As the large-scale language model, for example, generative pre-trained transformer-4 (GPT-4), pathways language model (PaLM), or the like may be used. The invention is not limited to a type of the large-scale language model.

The filtering unit 242 acquires the relationship document information 236 from the relationship document generation unit 233, and excludes, from interpretation sentences 244 to be output, the interpretation sentence 244 including a fact inconsistent with a fact expressed by the relationship document.

The result presentation unit 243 displays the interpretation sentence 244 not excluded by the filtering unit 242 on a screen.

Hereinafter, data structures of data and information handled by the computer system will be described.

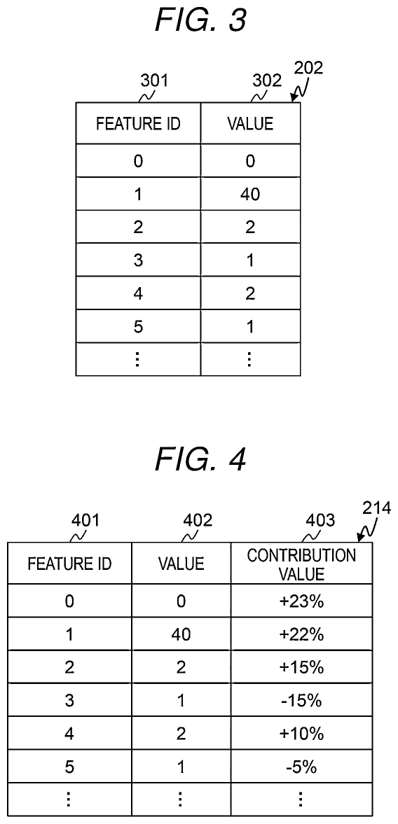

FIG. 3 is a diagram showing an example of a data structure of the input data 202 according to Embodiment 1.

The input data 202 includes a plurality of entries each including a feature ID 301 and a value 302. One entry corresponds to one feature.

The feature ID 301 is a field for storing an ID of the feature. The value 302 is a field for storing a value of the feature. In the prediction of the fire probability, the input data 202 is, for example, property data, and includes an age of a building, a construction method, and the like as features.

FIG. 4 is a diagram showing an example of a data structure of the contribution value information 214 according to Embodiment 1.

The contribution value information 214 includes a plurality of entries each including a feature ID 401, a value 402, and a contribution value 403. One entry corresponds to one feature.

The feature ID 401 and the value 402 are the same fields as the feature ID 301 and the value 302, respectively. The contribution value 403 is a field for storing a contribution value.

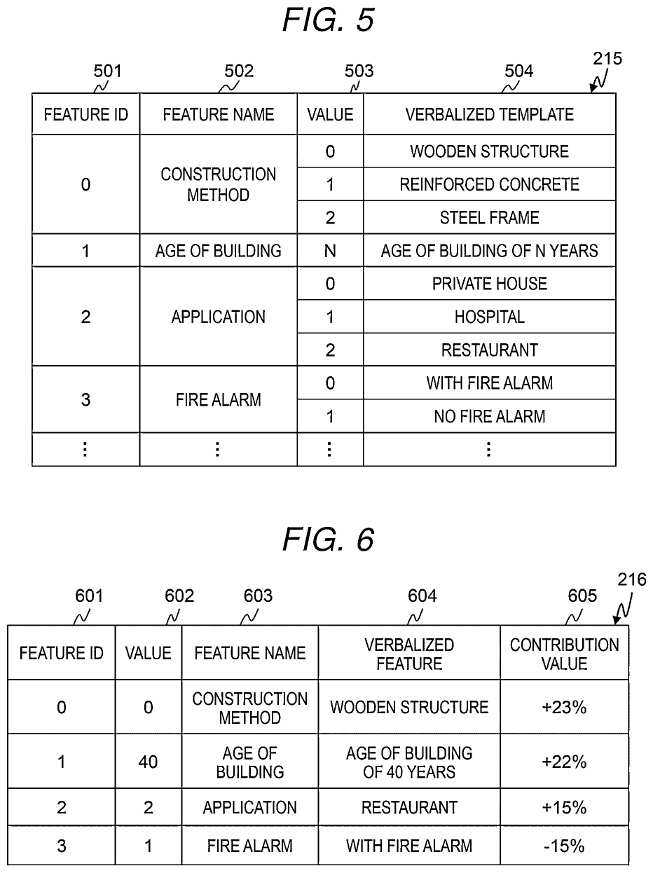

FIG. 5 is a diagram showing an example of a data structure of the feature information 215 according to Embodiment 1.

The feature information 215 stores entries each including a feature ID 501, a feature name 502, a value 503, and a verbalized template 504.

The feature ID 501 is the same field as the feature ID 301. The feature name 502 is a field for storing a name of the feature. The value 503 is a field for storing a value of the feature. One feature includes as many rows as the number of values that the feature can take. The verbalized template 504 is a field for storing a template for verbalizing the value of the feature. The template is a text in which the value of the feature is expressed in a language, and is set by the user based on the value and meaning of the feature.

FIG. 6 is a diagram showing an example of a data structure of the feature list 216 according to Embodiment 1.

The feature list 216 stores entries each including a feature ID 601, a value 602, a feature name 603, a verbalized feature 604, and a contribution value 605. One entry corresponds to one feature.

The feature ID 601 and the value 602 are the same fields as the feature ID 301 and the value 302, respectively. The feature name 603 is the same field as the feature name 502. The verbalized feature 604 is a field for storing a verbalized feature. The contribution value 605 is the same field as the contribution value 403.

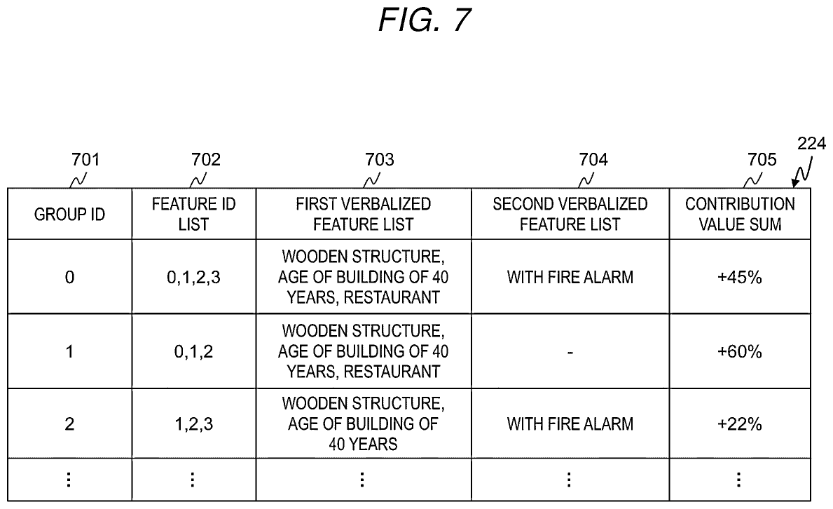

FIG. 7 is a diagram showing an example of a data structure of the group information 224 according to Embodiment 1.

The group information 224 stores entries each including a group ID 701, a feature ID list 702, a first verbalized feature list 703, a second verbalized feature list 704, and a contribution value sum 705. One entry corresponds to one group.

The group ID 701 is a field for storing an ID of the group. The feature ID list 702 is a field for storing a list of IDs of features that constitute the group. The first verbalized feature list 703 stores the verbalized feature whose contribution value is positive. The second verbalized feature list 704 stores the verbalized feature whose contribution value is negative. The contribution value sum 705 stores a sum of the contribution values of the features constituting the group.

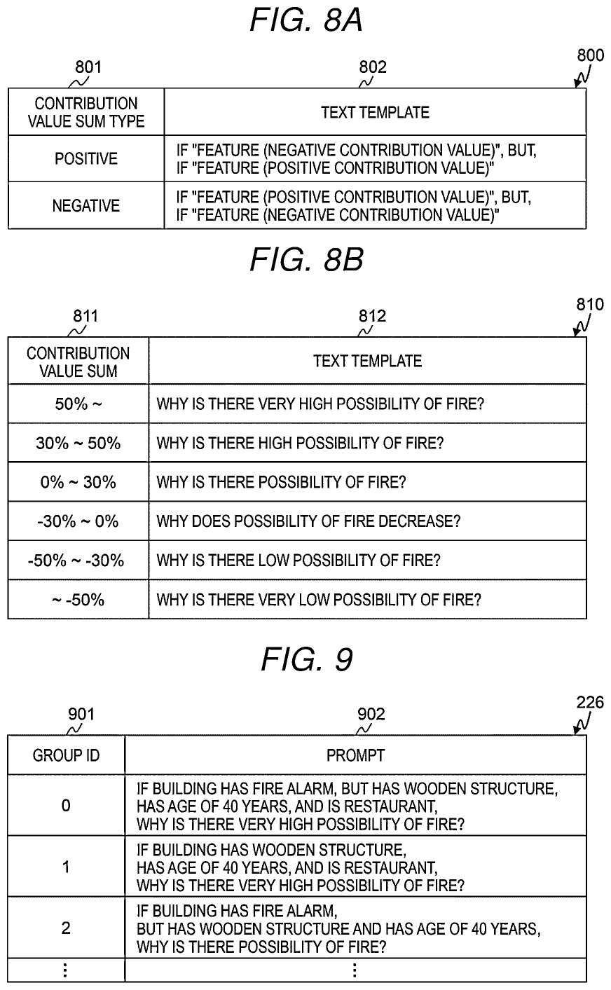

FIGS. 8A and 8B are diagrams showing an example of a data structure of the first text template information 225 according to Embodiment 1.

The first text template information 225 includes a template table 800 that stores templates each corresponding to a preceding sentence of the prompt, and a template table 810 that stores templates each corresponding to a main sentence of the prompt.

The template table 800 stores entries each including a contribution value sum type 801 and a text template 802.

The contribution value sum type 801 is a field for storing a type of the sum of the contribution values of the group. The text template 802 is a field for storing a template of the preceding sentence corresponding to the type of the sum of the contribution values of the group.

The template table 810 stores entries each including a contribution value sum 811 and a text template 812.

The contribution value sum 811 is a field for storing a range of the sum of the contribution values of the group. The text template 812 is a field for storing a template of the main sentence of the prompt corresponding to the sum of the contribution values. The main sentence is set in advance by the user.

In the present embodiment, the main sentence is a question sentence, but is not limited thereto. For example, an interpretation generation model may generate the following document as “a reason why is there a high possibility of a fire”.

A classification of the range of the contribution value shown in FIG. 8B is an example, and is not limited thereto.

FIG. 9 is a diagram showing an example of a data structure of the prompt information 226 according to Embodiment 1.

The prompt information 226 stores entries each including a group ID 901 and a prompt 902. One entry corresponds to one group.

The group ID 901 is the same field as the group ID 701. The prompt 902 is a field for storing a prompt generated based on the preceding sentence and the main sentence. The prompt is an input of the interpretation sentence generation unit 241.

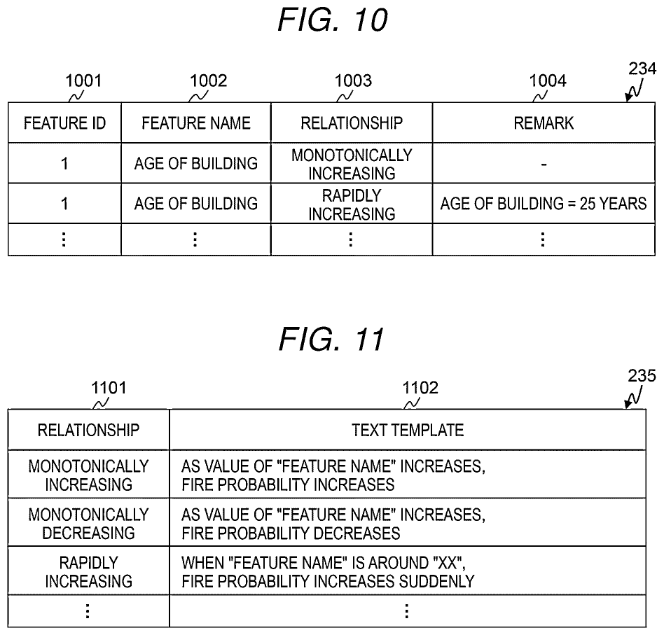

FIG. 10 is a diagram showing an example of a data structure of the analysis information 234 according to Embodiment 1.

The analysis information 234 stores entries each including a feature ID 1001, a feature name 1002, a relationship 1003, and a remark 1004.

The feature ID 1001 is the same field as the feature ID 301. The feature name 1002 is a field for storing a name of the feature. The relationship 1003 is a field for storing information indicating a relationship between the value of the feature and the contribution value. Possible relationships include monotonically increasing, monotonically decreasing, rapidly increasing, and the like. The remark 1004 is a field for storing information related to the relationship. For example, a value of a feature whose contribution value increases rapidly is stored.

FIG. 11 is a diagram showing an example of a data structure of the second text template information 235 according to Embodiment 1.

The second text template information 235 stores entries each including a relationship 1101 and a text template 1102.

The relationship 1101 is a field for storing a relationship between the value of the feature and the contribution value. The text template 1102 is a field for storing a template of a text in which the relationship is verbalized.

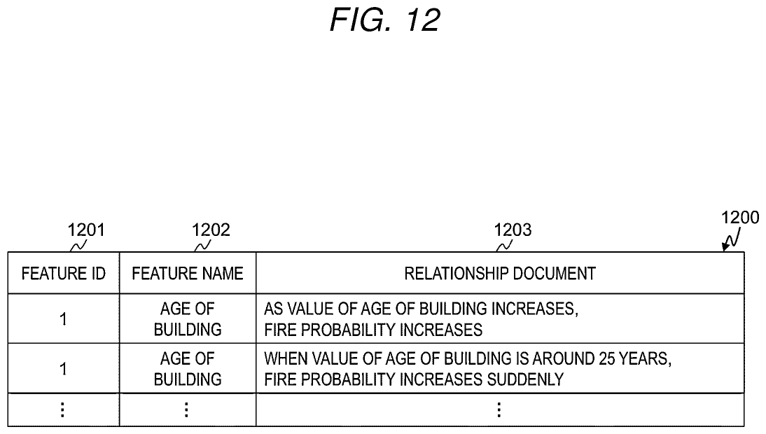

FIG. 12 is a diagram showing an example of a data structure of the relationship document information 236 according to Embodiment 1.

The relationship document information 236 stores entries each including a feature ID 1201, a feature name 1202, and a relationship document 1203. One entry corresponds to one relationship document.

The feature ID 1201 and the feature name 1202 are the same fields as the feature ID 1001 and the feature name 1002, respectively. The relationship document 1203 is a field for storing a document in which a relationship between the value of the feature and the contribution value is verbalized.

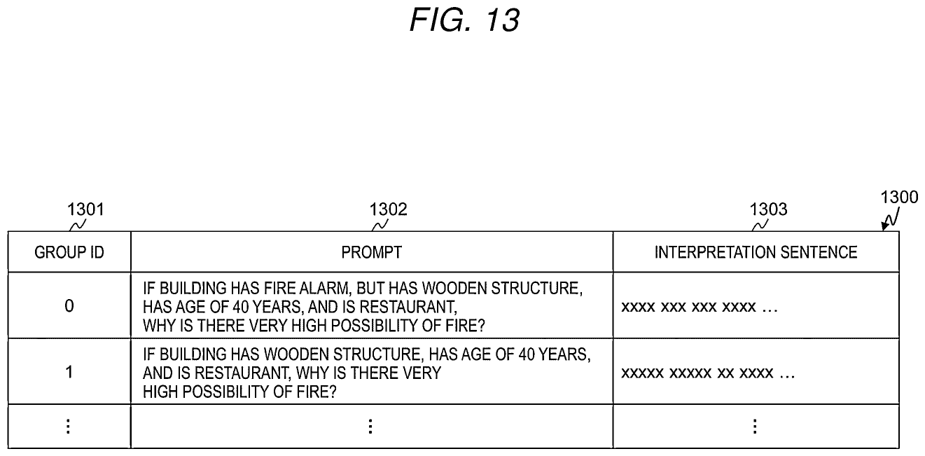

FIG. 13 is a diagram showing an example of a data structure of a table for managing the interpretation sentences 244 according to Embodiment 1.

A table 1300 stores entries each including a group ID 1301, a prompt 1302, and an interpretation sentence 1303. One entry corresponds to one group.

The group ID 1301 and the prompt 1302 correspond to the group ID 901 and the prompt 902, respectively. The interpretation sentence 1303 is a field for storing the interpretation sentence 244 obtained by inputting the prompt.

Next, processing executed by the interpretation sentence generation device 100 will be described. The interpretation sentence generation device 100 generates a business interpretation for the prediction value 203 and presents the business interpretation to the user.

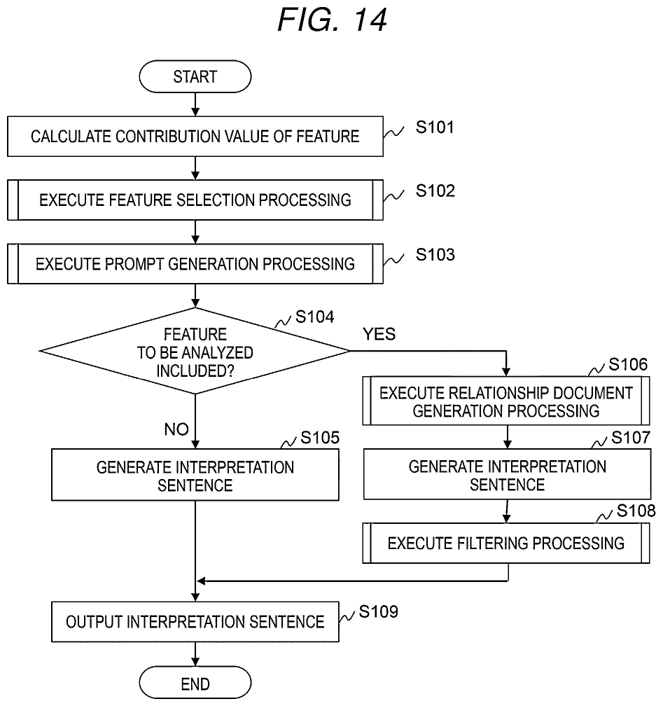

FIG. 14 is a flowchart illustrating an outline of the processing executed by the interpretation sentence generation device 100 according to Embodiment 1. In the present embodiment, an interpretation sentence for the prediction of the fire probability will be described as an example.

The XAI unit 211 of the interpretation sentence generation device 100 calculates a contribution value of each feature of the input data 202 by using the input data 202 and the prediction value 203 (step S101).

As a method of calculating the contribution value, for example, SHAP can be used. The SHAP uses a base line serving as a reference for calculating the contribution value. The XAI unit 211 determines the contribution value of each feature of the property data based on a relative value of the feature with a value of the base line as a reference. In this example, the XAI unit 211 calculates the contribution value of each feature of the property data (input data 202) input for calculating the fire probability.

Next, the interpretation sentence generation device 100 executes feature selection processing for selecting a feature to be used for generating a prompt (step S102).

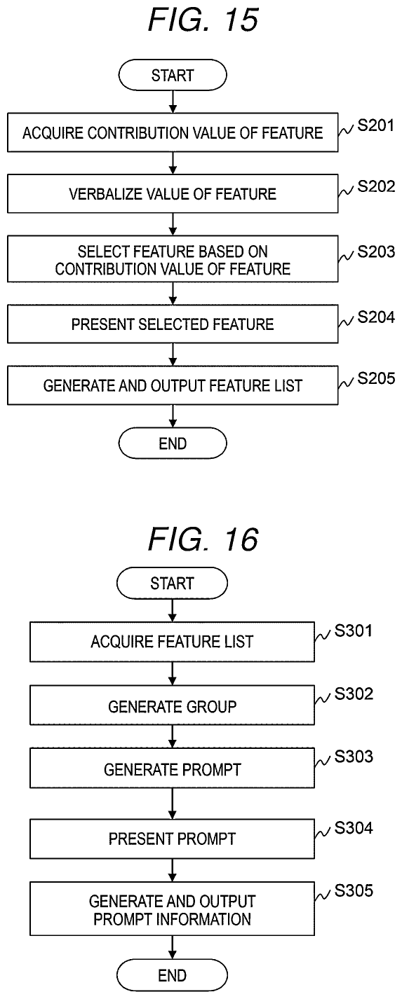

Here, the feature selection processing will be described. FIG. 15 is a flowchart illustrating an example of the feature selection processing executed by the interpretation sentence generation device 100 according to Embodiment 1.

The selection unit 212 acquires the contribution value information 214 (step S201).

Next, the selection unit 212 refers to the feature information 215 and verbalizes a value of the feature (step S202).

Specifically, the selection unit 212 refers to an entry with a matching feature ID for each feature, and acquires the verbalized template 504 of a row corresponding to the value 503. The selection unit 212 may use the verbalized template as it is, or may modify the template according to the value of the feature as necessary.

Next, the selection unit 212 selects the feature based on the contribution value of each feature (step S203).

Specifically, the selection unit 212 selects a predetermined number of features in descending order of an absolute value of the contribution value. Accordingly, it is possible to efficiently select features that are considered important by the inference model. In order to present the selected features, the selection unit 212 generates ranking information for storing entries each including a verbalized feature and the contribution value of the selected feature. The entries of the ranking information are sorted in descending order of the absolute value of the contribution value.

The feature presentation unit 213 presents the selected feature (step S204). That is, the ranking information is presented.

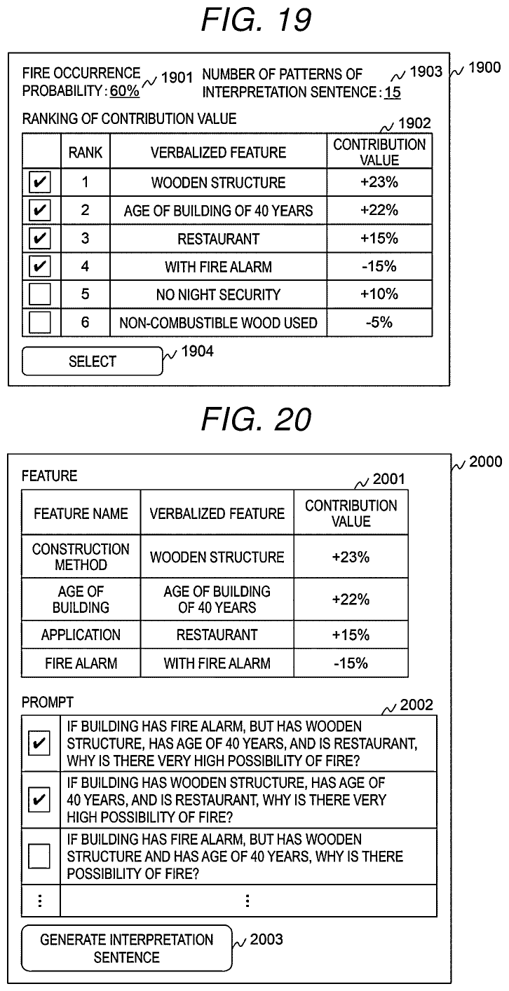

FIG. 19 is a diagram showing an example of a screen displayed by the feature presentation unit 213 according to Embodiment 1.

The feature presentation unit 213 displays a screen 1900 on the user terminal 120. The screen 1900 includes sections 1901 and 1903, ranking information 1902, and an operation button 1904.

The section 1901 is a section that displays the prediction value 203. The section 1903 is a section that displays the number of patterns of an interpretation sentence generated based on the selected feature. The number of patterns of the interpretation sentence corresponds to the number of groups.

The ranking information 1902 stores entries each including a check box for the user to select a feature to be used, a ranking, a verbalized feature, and a contribution value.

Normally, the selection unit 212 selects the feature to be used based on a magnitude of the absolute value of the contribution value, and adds a check to the check box of the selected feature. However, the user can also operate the check box to select the feature. By selecting the feature, the user can acquire information for generating an interpretation sentence that the user wants. When the number of patterns of the interpretation sentence displayed in the section 1903 is large, the user can reduce the number of features to be used.

When the operation button 1904 is pressed, information on the feature selected in the check box is transmitted to the selection unit 212.

The selection unit 212 generates and outputs the feature list 216 based on an operation on the screen 1900 (step S205).

The above is the description of the feature selection processing. Returning to the description of FIG. 14. The interpretation sentence generation device 100 executes prompt generation processing using the selected feature (step S103).

Here, the prompt generation processing will be described. FIG. 16 is a flowchart illustrating an example of the prompt generation processing executed by the interpretation sentence generation device 100 according to Embodiment 1.

The group generation unit 221 acquires the feature list 216 (step S301).

Next, the group generation unit 221 generates a group by combining the features registered in the feature list 216 (step S302). The group generation unit 221 registers information on the generated group in the group information 224. Here, groups are generated as many as the number of possible combinations of features. As to be described later, a prompt is generated for each group. Therefore, a variety of interpretation sentences 244 can be generated.

The prompt generation unit 222 refers to the first text template information 225 and generates a prompt for each group (step S303).

As shown in FIGS. 8A and 8B, in the first text template information 225, the sum of the contribution values of the group (characteristics of contribution values) and the corresponding text are managed in association with each other. The prompt generation unit 222 refers to the template table 800 in FIG. 8A and generates a preceding sentence based on the sum of the contribution values of each group. In addition, the prompt generation unit 222 refers to the template table 810 in FIG. 8B and generates a question sentence based on the sum of the contribution values of each group. The prompt generation unit 222 generates, as the prompt, a document in which the preceding sentence and the question sentence are combined.

The first text template information 225 according to Embodiment 1 is an example, and may include, for example, only one table or may include three or more tables. A table in which characteristics of the contribution values other than the sum of the contribution values are associated with the templates may be used.

Since the prompt is changed based on the feature and the contribution value of the feature included in the group, the first text template information 225 can generate a different prompt for each group. For example, by using the template table 800, it is possible to include an adversative conjunction corresponding to the positive or negative of the contribution value in the preceding sentence. This information represents a result of XAI, and the prompt can include information on the target inference model.

Next, the prompt presentation unit 223 presents the prompt generated by the prompt generation unit 222 (step S304).

FIG. 20 is a diagram showing an example of a screen displayed by the prompt presentation unit 223 according to Embodiment 1.

The prompt presentation unit 223 displays a screen 2000 on the user terminal 120. The screen 2000 includes a table 2001 corresponding to the feature list 216, a table 2002 corresponding to the prompt information 226, and an operation button 2003.

The table 2001 stores entries each including, for example, a name of a feature, a verbalized feature, and a contribution value. The entry may include a field for storing a value of the feature.

The table 2002 stores entries each including, for example, a check box and a prompt. The entry may include a field for storing the sum of the contribution values of each group and the like.

The check box is used to select a prompt to be input. By default, an interpretation sentence is generated for every prompt, but the user may select a prompt to be used by using the check box. An input format may be used in which the prompt can be corrected.

When the operation button 2003 is pressed, information on the prompt selected in the check box is transmitted to the prompt generation unit 222.

The prompt presentation unit 223 generates and outputs the prompt information 226 based on an operation on the screen 2000 (step S305).

The above is the description of the prompt generation processing. Returning to the description of FIG. 14. The interpretation sentence generation device 100 determines whether a feature to be analyzed is included in the selected feature (step S104). For example, in the prediction of the fire probability, an age of a building, a floor area, or the like is the feature to be analyzed. The feature to be analyzed is specified in advance by the user.

When the feature to be analyzed is not included in the selected feature (S104: NO), the interpretation sentence generation device 100 acquires the prompt information 226 and generates the interpretation sentence 244 (step S105). Specifically, the interpretation sentence generation unit 241 generates the interpretation sentence 244 by inputting the prompt to the large-scale language model.

When the feature to be analyzed is included in the selected feature (S104: YES), the interpretation sentence generation device 100 executes relationship document generation processing (step S106).

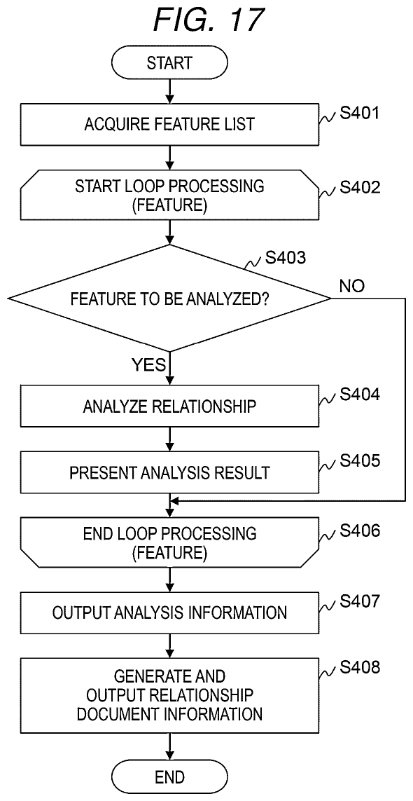

Here, the relationship document generation processing will be described. FIG. 17 is a flowchart illustrating an example of the relationship document generation processing executed by the interpretation sentence generation device 100 according to Embodiment 1.

The analysis unit 231 acquires the feature list 216 (step S401).

Next, the analysis unit 231 starts loop processing of the feature (step S402). Specifically, the analysis unit 231 selects one feature from the feature list 216.

The analysis unit 231 determines whether the selected feature is the feature to be analyzed (step S403).

When the selected feature is not the feature to be analyzed (S403: NO), the analysis unit 231 proceeds to step S406.

When the selected feature is the feature to be analyzed (S403: YES), the analysis unit 231 analyzes a relationship between the value of the feature and the contribution value (step S404). Specifically, the analysis unit 231 uses the XAI to analyze a change in a contribution value when a value of a target feature is changed, and depicts the change in a graph.

Next, the analysis result presentation unit 232 presents an analysis result (step S405).

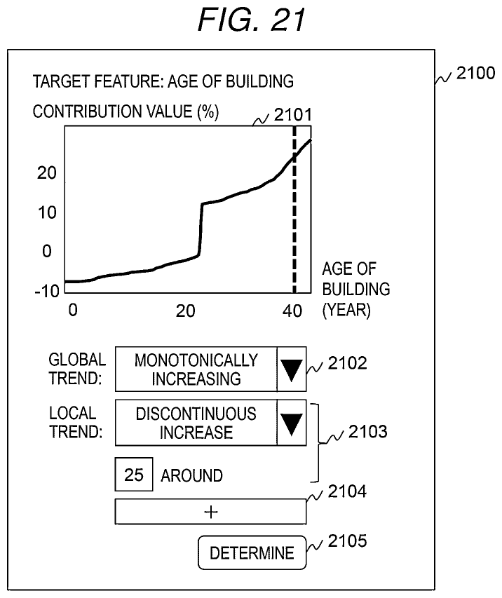

FIG. 21 is a diagram showing an example of a screen displayed by the analysis result presentation unit 232 according to Embodiment 1.

The analysis result presentation unit 232 displays a screen 2100 on the user terminal 120. The screen 2100 includes a graph 2101, input sections 2102 and 2103, and operation buttons 2104 and 2105.

The graph 2101 is a graph showing a relationship between the value of the feature and the contribution value. A horizontal axis indicates the value of the feature, and a vertical axis indicates the contribution value. The graph 2101 clearly shows the value of the feature in the input data 202 to be described. For example, the value of the feature is shown by a dotted line in FIG. 21.

The input sections 2102 and 2103 are sections for the user to confirm the graph and input the relationship.

The input section 2102 is used to input a global relationship. For example, the user selects a corresponding relationship from options such as monotonically increasing, monotonically decreasing, and none. The input section 2103 is used to input a local relationship. When there are a plurality of local relationships, the input section 2103 is added by pressing the operation button 2104. A change amount or the like may be added to the input section 2103.

When the operation button 2105 is pressed, information on the relationships input to the input sections 2102 and 2103 is output to the analysis unit 231. At this time, the analysis unit 231 adds an entry to the analysis information 234.

After receiving an operation of the operation button 2105, the analysis unit 231 determines whether the processing is completed for all the features (step S406).

When it is determined that the processing is not completed for all the features (S406: NO), the analysis unit 231 returns to step S402 and selects a new feature.

When it is determined that the processing is completed for all the features (S406: YES), the analysis unit 231 outputs the analysis information 234 (step S407).

The relationship document generation unit 233 refers to the second text template information 235 and verbalizes the relationship included in the analysis information 234 to generate and output the relationship document information 236 (step S408).

The above is the description of the relationship document generation Returning processing. to the The interpretation sentence description of FIG. 14. generation device 100 acquires the prompt information 226 and generates the interpretation sentence 244 (step S107). The processing of step S107 is the same as the processing of step S105.

The filtering unit 242 executes filtering processing of the interpretation sentence 244 using the relationship document (step S108).

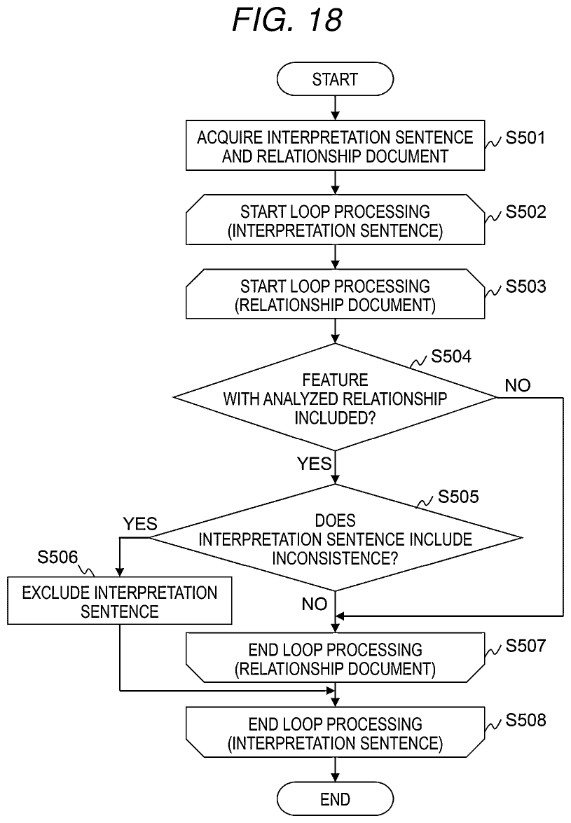

Here, the filtering processing will be described. FIG. 18 is a flowchart illustrating an example of the filtering processing executed by the interpretation sentence generation device 100 according to Embodiment 1.

The filtering unit 242 acquires the interpretation sentence 244 and the relationship document information 236 (step S501).

The filtering unit 242 starts loop processing of the interpretation sentence 244 (step S502). Specifically, the filtering unit 242 selects one interpretation sentence 244 from the interpretation sentences 244.

Next, the filtering unit 242 starts loop processing of the relationship document (step S503). Specifically, the filtering unit 242 selects one relationship document from the relationship document information 236. Only a relationship document indicating a global relationship may be selected.

The filtering unit 242 determines whether the selected interpretation sentence 244 includes a feature that is a target of the selected relationship document (step S504).

When the selected interpretation sentence does not include the feature that is the target of the selected relationship document (S504: NO), the filtering unit 242 proceeds to step S507.

When the selected interpretation sentence includes the feature that is the target of the selected relationship document (S504: YES), the filtering unit 242 determines whether the interpretation sentence 244 includes a fact inconsistent with the relationship document (step S505). For example, by performing recognizing textual entailment (RTE) using BERT, which is one of language models, it is possible to determine whether there is an entailment or inconsistence between two documents.

When it is determined that the interpretation sentence 244 does not include the fact inconsistent with the relationship document (S505: NO), the filtering unit 242 proceeds to step S507.

When it is determined that the interpretation sentence 244 includes the fact inconsistent with the relationship document (S505: YES), the filtering unit 242 excludes the interpretation sentence 244 from an output target (step S506). Then, the filtering unit 242 ends the loop on the relationship document and proceeds to step S508.

The relationship document represents the relationship between the value of the selected feature that is considered important by the inference model to be described and the contribution value. Since a behavior for the inference result of the target feature is not input to the interpretation generation model, there is a possibility that the interpretation sentence 244 including the fact inconsistent with the relationship document is output. Such the interpretation sentence 244 is not suitable for the interpretation sentence 244 for the inference result of the inference model, and thus is excluded in advance.

In step S507, the filtering unit 242 determines whether the processing is completed for all the relationship documents (step S507).

When it is determined that the processing is not completed for all the relationship documents (S507: NO), the filtering unit 242 returns to step S503 and selects a new relationship document.

When it is determined that the processing is completed for all the relationship documents (S507: YES), the filtering unit 242 proceeds to step S508.

In step S508, the filtering unit 242 determines whether the processing is completed for all the interpretation sentences 244 (step S508).

When it is determined that the processing is not completed for all the interpretation sentences 244 (S508: NO), the filtering unit 242 returns to step S502 and selects a new interpretation sentence 244.

When it is determined that the processing is completed for all the interpretation sentences 244, the filtering unit 242 ends the filtering processing.

The above is the description of the filtering processing. Returning to the description of FIG. 14. The result presentation unit 243 acquires and outputs the interpretation sentence 244 (step S109).

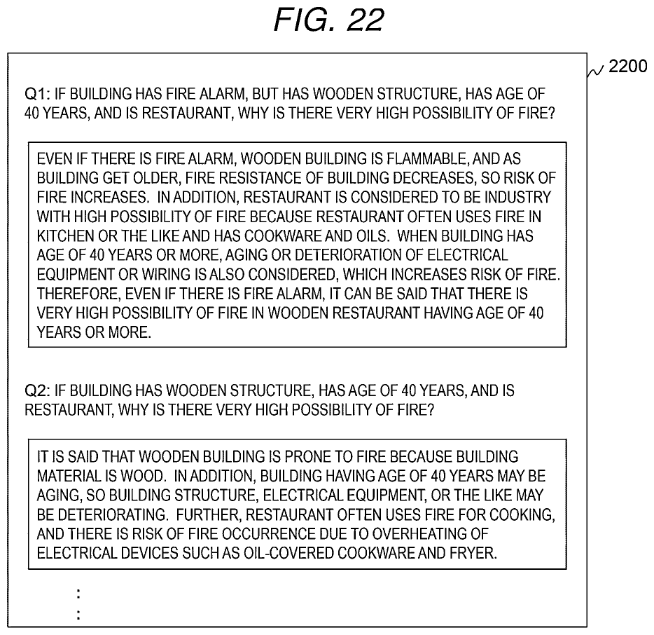

FIG. 22 is a diagram showing an example of a screen 2200 displayed by the result presentation unit 243 according to Embodiment 1.

The result presentation unit 243 displays the screen 2200 on the user terminal 120. The screen 2200 displays prompts and interpretation sentences.

As described above, according to the present embodiment, the interpretation sentence generation device 100 can generate and present an interpretation sentence reflecting business knowledge without receiving an input of specialized knowledge from a user.

The invention is not limited to the above-described embodiment, and includes various modifications. For example, the above-described embodiment has been described in detail to facilitate understanding of the invention, and the invention is not necessarily limited to those including all the described configurations. A part of a configuration in each embodiment can be added to, deleted from, or replaced with another configuration.

A part or all of the configurations, functions, processing units, processing methods, and the like described above may be implemented by hardware by, for example, designing with an integrated circuit. The invention can also be implemented by a program code of software for implementing the functions of the embodiment. In this case, a storage medium storing the program code is provided to a computer, and a processor provided in the computer reads the program code stored in the storage medium. In this case, the program code read from the storage medium implements the functions of the embodiment described above by itself, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a nonvolatile memory card, and a ROM.

Further, the program code for implementing the functions described in the present embodiment can be implemented in a wide range of programs or script languages such as assembler, C/C++, Perl, Shell, PHP, Python, and Java (registered trademark).

Further, the program code of software for implementing the functions of the embodiment may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are shown in the embodiment described above, and not all control lines and information lines in a product are necessarily shown. All the configurations may be connected to one another.

What is claimed is:

1. A computer system, wherein
the computer system
is connected to an inference system that receives input data including a plurality of features and performs an inference using an inference model,
stores a large-scale language model that receives an instruction sentence as an input and outputs an interpretation sentence for interpreting a result of the inference, and first text template information that stores first template data in which a characteristic of a contribution value indicating a magnitude of a contribution to the result of the inference of a feature in a group constituted with one or more features is associated with a template of the instruction sentence,
calculates the contribution value of each of the plurality of features using the input data, the result of the inference, and the inference model,
generates a plurality of groups each constituted with one or more of the features,
acquires, for each of the plurality of groups, the first template data by referring to the first text template information based on the characteristic of the contribution value of the feature included in the group,
generates, based on the acquired first template data and the feature included in the group, the instruction sentence to be input to the large-scale language model, and
outputs the interpretation sentence obtained by inputting the instruction sentence to the large-scale language model.

2. The computer system according to claim 1, wherein
the computer system
stores second text template information that stores second template data in which a relationship between a value of the feature and the contribution value is associated with a second template for verbalizing the relationship,
analyzes the relationship for the feature for which the relationship needs to be analyzed,
specifies the second template data by referring to the second text template information based on a result of the analysis,
generates a relationship document that verbalizes the relationship, based on the specified second template data and the feature for which the relationship needs to be analyzed,
executes language processing for determining whether the interpretation sentence includes a fact inconsistent with the relationship corresponding to the relationship document, and
excludes, from the interpretation sentence to be output, the interpretation sentence including the fact inconsistent with the relationship indicated in the relationship document.

3. The computer system according to claim 2, wherein
the computer system
selects a plurality of target features based on magnitudes of the contribution values of the plurality of features, and
generates the group having the plurality of target features as elements.

4. The computer system according to claim 3, comprising:
an interface configured to correct the target feature;
an interface configured to select the instruction sentence to be input to the large-scale language model; and
an interface configured to input or correct the relationship.

5. A method for generating an interpretation sentence for interpreting an inference result of an inference model, the method configured to be executed by a computer system, wherein
the computer system
is connected to an inference system that receives input data including a plurality of features and performs an inference using an inference model, and
stores a large-scale language model that receives an instruction sentence as an input and outputs an interpretation sentence for interpreting a result of the inference, and first text template information that stores first template data in which a characteristic of a contribution value indicating a magnitude of a contribution to the result of the inference of a feature in a group constituted with one or more features is associated with a template of the instruction sentence, and
the method comprises:
a first step of calculating, by the computer system, the contribution value of each of the plurality of features using the input data, the result of the inference, and the inference model;
a second step of generating, by the computer system, a plurality of groups each constituted with one or more of the features;
a third step of acquiring, by the computer system, for each of the plurality of groups, the first template data by referring to the first text template information based on the characteristic of the contribution value of the feature included in the group;
a fourth step of generating, by the computer system, based on the acquired first template data and the feature included in the group, the instruction sentence to be input to the large-scale language model; and
a fifth step of outputting, by the computer system, the interpretation sentence obtained by inputting the instruction sentence to the large-scale language model.

6. The method for generating an interpretation sentence according to claim 5, wherein
the computer system stores second text template information that stores second template data in which a relationship between a value of the feature and the contribution value is associated with a second template for verbalizing the relationship,
the method comprises:
a sixth step of analyzing, by the computer system, the relationship for the feature for which the relationship needs to be analyzed;
a seventh step of specifying, by the computer system, the second template data by referring to the second text template information based on a result of the analysis; and
an eighth step of generating, by the computer system, a relationship document that verbalizes the relationship, based on the specified second template data and the feature for which the relationship needs to be analyzed, and
the fifth step includes
executing, by the computer system, language processing for determining whether the interpretation sentence includes a fact inconsistent with the relationship corresponding to the relationship document, and
excluding, by the computer system, from the interpretation sentence to be output, the interpretation sentence including the fact inconsistent with the relationship indicated in the relationship document.

7. The method for generating an n interpretation sentence according to claim 6, wherein
the second step includes
selecting, by the computer system, a plurality of target features based on magnitudes of the contribution values of the plurality of features, and
generating, by the computer system, the group having the plurality of target features as elements.

8. The method for generating an interpretation sentence according to claim 7, wherein
the second step includes providing, by the computer system, an interface configured to correct the target feature,
the fifth step includes providing, by the computer system, an interface configured to select the instruction sentence to be input to the large-scale language model, and
the eighth step includes providing, by the computer system, an interface configured to input or correct the relationship.
